(19) United States
(12) Patent Application Publication
(10) Pub. No.: US 2002/0190668 A1
(43) Pub. Date: Dec. 19, 2002

(54) High-pressure discharge lamp

(75) Inventors: Wolfram Graser, Muenchen (DE); Roland Huettinger, Kaufering (DE); Andreas Kloss, Unterhaching (DE); Klaus Stockwald, Muenchen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MGH, Munchen (DE)

(21) Appl. No.: 10/152,617

(22) Filed: May 23, 2002

(30) Foreign Application Priority Data
Jun. 19, 2001 (DE) 101 29 229.5

(51) Int. Cl. G05F 1/00

(52) U.S. Cl. 315/326

(57) ABSTRACT

The invention relates to a high-pressure discharge lamp, in particular a metal halide high-pressure discharge lamp, and a method for operating this lamp with the aid of a square-wave alternating current. According to the invention, the electrodes (2) of the lamp are dimensioned such that during operation of the lamp with its prescribed nominal power and with a substantially square-wave alternating current the product of the current density in the electrodes (2) and the cube root of the root mean square value of the alternating current has a constant value of between 5 A^{4/3}mm⁻² and 10 A^{4/3}mm⁻² during the stable operating state of the high-pressure discharge lamp after termination of the ignition phase.

### TECHNICAL FIELD

The invention relates to a high-pressure discharge lamp having a discharge vessel, having a discharge medium enclosed therein, and having cylindrical electrodes for producing a gas discharge in the discharge medium, and to an operating method for a high-pressure discharge lamp that has a discharge vessel having a discharge medium enclosed therein and electrodes for producing a gas discharge in the discharge medium, and having a substantially square-wave alternating current.

### BACKGROUND ART

It is known that high-pressure discharge lamps that have been designed for operating on what is termed a conventional ballast with a substantially sinusoidal line-frequency alternating voltage can also be operated on an electronic ballast with a substantially square-wave alternating voltage at a frequency from the range of approximately 100 Hz to 500 Hz. The operation of these high-pressure discharge lamps on an electronic ballast has various advantages by contrast with the operation on a conventional ballast. For example, it is possible to ensure a better color constancy by correcting the lamp power for changes in the lamp operating voltage or in the line voltage, and to achieve elimination of the light flicker.

A high-pressure discharge lamp in accordance with the preamble of claim 1, and an operating method in accordance with the preamble of claim 3 are disclosed by way of example in European laid-open specifications EP 1 045 622 A2 and EP 0 908 926 A2. The first-named laid-open specification describes a ballast for operating a mercury-free metal halide high-pressure discharge lamp with the aid of a square-wave alternating current at a frequency of between 50 Hz and 5 kHz. The other laid-open specification discloses a metal halide high-pressure discharge lamp with a filling based on sodium and scandium, that is operated with the aid of square-wave pulses of 270 Hz.

### DISCLOSURE OF THE INVENTION

It is the object of the invention to provide a high-pressure discharge lamp that has as little blackening of the lamp vessel as possible during operation with the aid of a substantially square-wave alternating current, and to specify a method for operating a high pressure discharge lamp with the aid of a substantially square-wave alternating current, such that as little blackening as possible of the lamp vessel occurs during operation.

This object is achieved according to the invention by means of the features of patent claim 1 and patent claim 3. Particularly advantageous designs of the invention are described in the dependent patent claims.

The high-pressure discharge lamp according to the invention has a discharge vessel with a discharge medium enclosed therein and cylindrical electrodes for producing a gas discharge in the discharge medium. The diameter of the electrodes is dimensioned such that during operation of the lamp with its prescribed nominal power and with a substantially square-wave alternating current the product of the current density in the electrodes and the cube root of the root mean square value of the alternating current has a constant value in the range between 5 A^{4/3}mm⁻² and 10 A^{4/3}mm⁻² during the stable operating state of the high-pressure discharge lamp after termination of the ignition phase. Since the root mean square value of the alternating current is fixed by the nominal data of the high-pressure discharge lamp, and the current density is yielded as the quotient of the root mean square value of the alternating current and the electrode cross section, the previous indication of range for the above-mentioned product signifies an instruction for dimensioning the diameter of the cylindrical electrodes of the high-pressure discharge lamp according to the invention. Only if the product of the current density in the electrodes and the cube root of the root mean square value of the alternating current has a constant value in the range between 5 A^{4/3}mm⁻² and 10 A^{4/3}mm⁻² is the blackening of the lamp vessel minimal in the case of operation of the high-pressure discharge lamp with the aid of a square-wave alternating current. If the electrode diameter of the lamp is dimensioned such that a smaller value than 5 A^{4/3}mm⁻² results for the product, an intensified blackening of the lamp vessel therefore occurs because of the increased sputtering of electrode material. However, if the lamp electrodes are dimensioned such that the above-named product assumes a larger value than 10 A^{4/3}mm⁻², an intensified blackening of the lamp vessel occurs because of the increased vapor deposition of electrode material.

As already mentioned above, the electrodes of the high-pressure discharge lamp according to the invention are of cylindrical design. This means that at least the section of the electrodes that projects into the discharge space has a uniform thickness or a standard diameter. The end of the electrodes on the discharge side can, however, be of rounded design. Such electrodes are usually denoted as pin electrodes or as bar electrodes. In order to optimize the thermal properties of these electrodes, the end of the electrodes on the discharge side can bear an electrode filament arranged coaxially with the electrode bar.

In accordance with a preferred exemplary embodiment of the invention, the electrodes of the high-pressure discharge lamp are designed as cylindrical pins which consist of a high melting metal, for example of tungsten. In this case, the thickness or the diameter of the pins is dimensioned in such a way that during operation of the lamp with its nominal power and with a substantially square-wave alternating current the product of the current density in the electrodes and the cube root of the root mean square value of the alternating current has a constant value of between 5 A^{4/3}mm⁻² and 10 A^{4/3}mm⁻² during the stable operating state of the high-pressure discharge lamp after termination of the ignition phase, in order to ensure as little blackening as possible of the lamp vessel during operation.

In accordance with another, preferred exemplary embodiment of the invention, the electrodes of the high-pressure discharge lamp respectively comprise a cylindrical electrode pin that bears at its end on the discharge side an electrode filament arranged coaxially with the electrode pin. In order to ensure as little blackening as possible of the lamp vessel, the diameter of the electrode pin is dimensioned in such a way that during operation of the lamp with a substantially square-wave alternating current the product of the current density in the electrodes and the cube root of the root mean square value of the alternating current has a constant value of between 5 A^{4/3}mm⁻² and 10 A^{4/3}mm⁻² during the stable operating state of the high-pressure discharge lamp after termination of the ignition phase.

In order to cause as little blackening as possible of the lamp vessel, in the operating method according to the invention for the high-pressure discharge lamp it is proposed to dimension the substantially square-wave alternating current through the electrodes in such a way that during the stable operating state of the high-pressure discharge lamp after termination of the ignition phase of the high-pressure discharge lamp the product of the current density in the electrodes and the cube root of the root mean square value of the alternating current has a constant value of between 5 A^{4/3}mm⁻² and 10 A^{4/3}mm⁻². If a low square-wave alternating current is applied to the electrodes such that the above product assumes a smaller value than 5 A^{4/3}mm⁻², increased blackening of the lamp vessel occurs on the basis of sputtering electrode material. On the other hand, if a higher square wave alternating current is applied to the electrodes such that the above product assumes a greater value than 10 A^{4/3}mm⁻², vapor-deposited electrode material causes an intensified blackening of the lamp vessel.

The frequency of the square-wave alternating current is preferably at a value of between 50 Hz and 500 Hz. Problems can arise with acoustic resonances in the discharge medium in the case of higher frequencies. Moreover, complicated electronics are required in the case of higher frequencies. Given excessively low frequencies, by contrast, flickering of the discharge arc of the lamp can become visible.

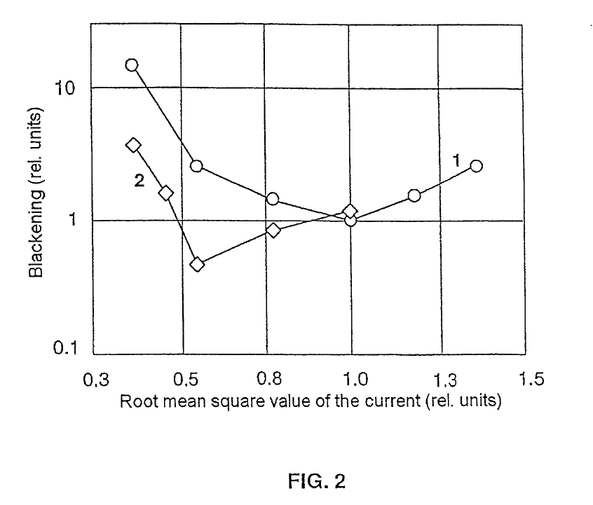

By way of example for a type of high-pressure discharge lamp, FIG. 2 illustrates a comparison of the blackening of the discharge vessel during operation with a substantially sinusoidal, line-frequency alternating current (curve 1) and during operation with a substantially square-wave alternating current (curve 2) at a frequency of 50 Hz. The root mean square value of the current of the lamp is plotted on the horizontal axis of the diagram from FIG. 2, and the blackening of the discharge vessel is plotted on the vertical axis (on a logarithmic scale), in relative units in each case. The current and the blackening at the minimum on curve 1 serve as reference values. Both curves show a minimum blackening behavior for a specific current. If the lamp is operated with an excessively low current, the blackening of the discharge vessel increases on the basis of sputtering of the electrode material. If, however, the lamp is operated with an excessively high current, the blackening of the discharge vessel increases on the basis of vapor-deposited electrode material. It is clearly to be seen that when operating the high-pressure discharge lamp with a square-wave alternating current an absolute minimum is reached in the blackening of the discharge vessel when the root mean square value of the current during operation with a square-wave alternating current is approximately 56% of the root mean square value of the current during operation with a sinusoidal, line-frequency alternating current at the minimum on curve 1.

It is seen that the minimum of the blackening of the discharge vessel during operation of high-pressure discharge lamps optimized empirically to the smallest reduction in luminous flux during their service life on sinusoidal, line-frequency alternating current occurs precisely when their nominal current is applied to these lamps. In the case of known high-pressure discharge lamps that operate on a sinusoidal, line-frequency alternating current, the product of the current density in the electrodes and the cube root of the root mean square value of the alternating current has a constant value of greater than 10 A^{4/3}mm⁻².

In order to reduce the blackening of the lamp vessel, that is to say of the discharge vessel, according to the invention the current density in the electrodes is set such that the product of the current density in the electrodes and the cube root of the root mean square value of the alternating current has a constant value of between 5 A^{4/3}mm⁻² and 10 A^{4/3}mm⁻². This is achieved in the case of the high-pressure discharge lamp according to the invention with cylindrical electrodes that are preferably designed as pin electrodes and additionally bear an electrode filament at their heads by an appropriate adaptation of their electrode pin diameter.

### BEST MODE FOR CARRYING OUT THE INVENTION

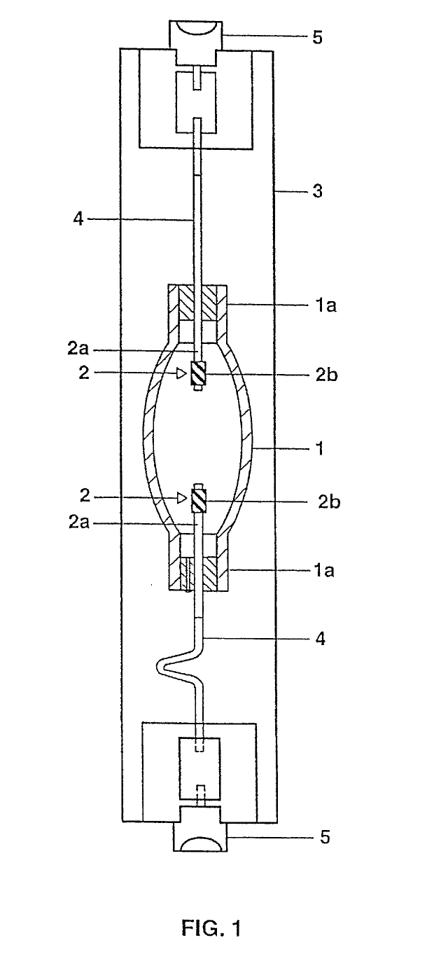

The invention is explained below in more detail with the aid of a plurality of preferred exemplary embodiments. FIG. 1 shows a schematic illustration of the design of the high-pressure discharge lamps in accordance with all the exemplary embodiments. The design of the lamp is substantially the same in all exemplary embodiments. They differ from one another only in their dimensions and their operating data.

The high-pressure discharge lamp illustrated in FIG. 1 has a discharge vessel 1 that is sealed at both ends and consists of a transparent material such as, for example, quartz glass or aluminum oxide ceramic. Enclosed in a gastight fashion in the interior of the discharge vessel 1 is an ionizable discharge medium that contains as essential components metal halides and, additionally, an inert gas or else mercury. Serving to produce a gas discharge in the discharge medium are two electrodes 2 of similar construction that are arranged diametrically in the discharge vessel 1. Each of the two electrodes 2 comprises a cylindrical electrode pin 2a that bears at the end on the discharge side an electrode filament 2b arranged coaxially with the electrode pin 2a. The discharge vessel 1 is surrounded for its part by a transparent outer bulb 3. The electrodes 2 are each connected to electric contacts 5 of the lamp via a supply lead 4 sealed in a gastight fashion into the discharge vessel ends 1a.

The first exemplary embodiment of the invention is a metal halide high-pressure discharge lamp with an electric power consumption, that is to say with a nominal power, of 70 W. The electrode pins 2a of this lamp have a diameter of 0.41 mm. This lamp is operated with the aid of a substantially square-wave alternating current of 120 Hz. After termination of the ignition phase of the lamp, when a quasi-stationary equilibrium operating state has been reached in which the lamp is operated at its nominal power, the root mean square value of the alternating current is 1 A, and the current density in the electrodes is 7.6 A/mm². The power factor is approximately 1, and the operating voltage is 70 V. The product of the current density in the electrodes and the cube root of the root mean square value of the alternating current is therefore calculated as 7.6 A^{4/3}mm⁻².

The second exemplary embodiment of the invention is a metal halide high-pressure discharge lamp with an electric power consumption, that is to say with a nominal power, of 150 W. The electrode pins 2a of this lamp have a diameter of 0.62 mm. This lamp is operated with the aid of a substantially square-wave alternating current of 120 Hz. After termination of the ignition phase of the lamp, when a quasi-stationary equilibrium operating state is reached in which the lamp is operated at its nominal power, the root mean square value of the alternating current is 1.8 A, and the current density in the electrodes is 6 A/mm². The power factor is approximately 1 and the operating voltage is 83.3 V. The product of the current density in the electrodes and the cube root of the root mean square value of the alternating current is therefore calculated as 7.3 A^{4/3}mm⁻².

The third exemplary embodiment of the invention is a metal halide high-pressure discharge lamp with an electric power consumption, that is to say with a nominal power, of 150 W. The electrode pins 2a of this lamp have a diameter of 0.33 mm. This lamp is operated with the aid of a substantially square-wave alternating current of 120 Hz. After termination of the ignition phase of the lamp, when a quasi-stationary equilibrium operating state has been reached in which the lamp is operated at its nominal power, the root mean square value of the alternating current is 0.75 A, and the current density in the electrodes is 8.8 A/mm². The power factor is approximately 1, and the operating voltage is 200 V. The product of the current density in the electrodes and the cube root of the root mean square value of the alternating current is therefore calculated as 8.0 A^{4/3}mm⁻².

The fourth exemplary embodiment of the invention is a mercury-free metal halide high-pressure discharge lamp with an electric power consumption, that is to say with a nominal power, of 150 W. The electrode pins 2a of this lamp have a diameter of 0.72 mm. This lamp is operated with the aid of a substantially square-wave alternating current of 120 Hz. After termination of the ignition phase of the lamp, when a quasi-stationary equilibrium operating state has been reached in which the lamp is operated at its nominal power, the root mean square value of the alternating current is 2.5 A, and the current density in the electrodes is 6.1 A/mm². The power factor is approximately 1, and the operating voltage is 60 V. The product of the current density in the electrodes and the cube root of the root mean square value of the alternating current is therefore calculated as 8.3 A^{4/3}mm⁻².

The fifth exemplary embodiment of the invention is a metal halide high-pressure discharge lamp with an electric power consumption, that is to say with a nominal power, of 250 W. The electrode pins 2a of this lamp have a diameter of 0.88 mm. This lamp is operated with the aid of a substantially square-wave alternating current of 120 Hz. After termination of the ignition phase of the lamp, when a quasi-stationary equilibrium operating state is reached in which the lamp is operated at its nominal power, the root mean square value of the alternating current is 3 A, and the current density in the electrodes is 4.9 A/mm². The power factor is 1 and the operating voltage is 83.3 V. The product of the current density in the electrodes and the cube root of the root mean square value of the alternating current is therefore calculated as 7.1 A^{4/3}mm⁻².

The sixth exemplary embodiment of the invention is a metal halide high-pressure discharge lamp with an electric power consumption, that is to say with a nominal power, of 400 W. The electrode pins 2a of this lamp have a diameter of 1.1 mm. This lamp is operated with the aid of a substantially square-wave operating current of 120 Hz. After termination of the ignition phase of the lamp, when a quasi-stationary equilibrium operating state is reached in which the lamp is operated at its nominal power, the root mean square value of the operating current is 4 A, and the power density in the electrodes is 4.2 A/mm². The power factor is 1, and the operating voltage is 100 V. The product of the current density in the electrodes and the cube root of the root mean square value of the alternating current is therefore calculated as 6.7 A^{4/3}mm⁻².

The invention is not limited to the exemplary embodiments described in more detail above. For example, the electrodes can also be designed as pin electrodes that consist of a high-melting metal, for example of tungsten, and bear no electrode filaments. In this case, the thickness or the diameter of the pin must be dimensioned such that the product of the current density in the electrodes and the cube root of the root mean square value of the alternating current has a constant value of between 5 A^{4/3}mm⁻² and 10 A^{4/3}mm⁻².

Moreover, the application of the invention is not limited to a special frequency of the square-wave alternating current. A frequency from the range of 50 Hz to 500 Hz is advantageously selected for the substantially square-wave alternating current.

Furthermore, the invention is not limited to the high-pressure discharge lamps sealed at two ends and provided with bases at two ends as illustrated schematically in FIG. 1. The geometry of the discharge vessel, and the way the outer bulb is provided with bases are of no importance for the invention. In particular, the invention can also be applied to high-pressure discharge lamps having a discharge vessel sealed at one end, and to high-pressure discharge lamps provided with a base at one end.

What is claimed is:

1. A high-pressure discharge lamp having a discharge vessel, having a discharge medium enclosed therein, and having cylindrical electrodes for producing a gas discharge in the discharge medium, wherein the diameter of the electrodes is dimensioned such that during operation of the lamp with its prescribed nominal power and with a substantially square-wave alternating current the product of the current density in the electrodes and the cube root of the root mean square value of the alternating current has a constant value of between 5 A^{4/3}mm⁻² and 10 A^{4/3}mm⁻² during the stable operating state of the high-pressure discharge lamp after termination of the ignition phase.

2. The high-pressure discharge lamp as claimed in claim 1, wherein the electrodes in each case comprise a rod-shaped electrode pin that bears at its end on the discharge side an electrode filament arranged coaxially with the electrode pin, the diameter of the electrode pin being dimensioned such that during operation of the lamp with a substantially square-wave alternating current the product of the current density in the electrodes and the cube root of the root mean square value of the alternating current has a constant value of between 5 A^{4/3}mm⁻² and 10 A^{4/3}mm⁻² during the stable operating state of the high-pressure discharge lamp after termination of the ignition phase.

3. A method for operating a high-pressure discharge lamp that has a discharge vessel having a discharge medium enclosed therein and electrodes for producing a gas discharge in the discharge medium, and having a substantially square-wave alternating current, wherein a substantially square-wave alternating current is applied to the high-pressure discharge lamp during the stable operating state of the high-pressure discharge lamp after termination of the ignition phase of the high-pressure discharge lamp such that the product of the current density in the electrodes and the cube root of the root mean square value of the alternating current has a constant value of between 5 A^{4/3}mm⁻² and 10 A^{4/3}mm⁻².
